(19) United States
(12) Patent Application Publication
(10) Pub. No.: US 2019/0340750 A1
(43) Pub. Date: Nov. 7, 2019

(54) INSPECTION METHOD FOR SIDE PLATE OF TIRE MOLD

(71) Applicant: Toyo Tire Corporation, Itami-shi (JP)

(72) Inventors: Siyi Ren, Itami-shi (JP); George Lashkhia, Aichi (JP)

(73) Assignee: Toyo Tire Corporation, Itami-shi (JP)

(21) Appl. No.: 16/388,090

(22) Filed: Apr. 18, 2019

(30) Foreign Application Priority Data
May 2, 2018 (JP) 2018-088773

(51) Int. Cl. G06T 7/00; G06K 9/62; G06T 7/13; B29D 30/72; B29D 30/06

(52) U.S. Cl. CPC G06T 7/0008; G06K 9/6204; G06T 7/13; B29D 30/72; B29D 30/0662; B29D 2030/0066; G06K 2209/01; G06T 2207/30116; G06T 2207/10028; B29D 2030/726; B29D 30/0606

(57) ABSTRACT

An inspection method according to an embodiment includes a step of constructing a template by imaging a symbol based on design data, a stop of detecting a symbol group including a plurality of templates, a step of template matching that searches for a symbol set part having the same shape as the symbol groin in a measured image, makes the positions and the sizes of the symbol group and the symbol set part having been searched for identical, and superimposes all symbols in the design data on all symbols in the measured image, a step of contour matching that compares the contours of the superimposed symbols in the design data with the contours of the symbols in the measured image, and a step of deciding whether the symbols corresponding to each other in the measured image and the design data match based on the template matching and the contour matching.

### CROSS-REFERENCE TO RELATED APPLICATION

This application is based upon and claims the benefit of priority of the prior Japanese Patent Application No. 2018-88773, filed on May 2, 2018, the entire contents of which are incorporated herein by reference.

### TECHNICAL FIELD

The present invention relates to an inspection method for a side plate of a tire mold.

### BACKGROUND ART

A tire mold used for vulcanizing molding of a tire includes a side plate corresponding to the side wall part of the tire, a sector corresponding to the tread part of the tire and the bead ring corresponding to the bead part of the tire. Of these components, the side plate is an annular member in plan view and the upper surface thereof is a molding surface (surface that makes contact with the tire in vulcanizing molding).

The molding surface of the side plate is provided with a plurality of concavo-convex characters for forming characters on the side wall part of the tire. A set of the plurality of characters forms a word. Such words and the like are formed on the side plate.

By the way, when the characters on the side plate do not meet the design, a tire having wrong characters in the side wall part thereof is produced. Accordingly, after the side plate is manufactured, it is necessary to inspect whether the characters on the side plate meet the design.

Conventionally, this inspection is performed visually. It has been proposed to inspect the characters on a tire instead of the side plate as described in PTL 1.

However, in the method that visually inspects the side plate, the inspector requires much effort and may miss a failure In addition, in the method that inspects a tire itself, inconformity of characters with the design can be decided by inspection only after many tires have been already manufactured and the tires manufactured before the decision go waste.

Therefore, it has been proposed that the measured data of the three-dimensional shape of the side plate is compared with three-dimensional design data for inspection using a computer, as described in PTL 2. Comparison between the measured data and design data needs a device for association (superimposition) between the positions of a plurality of measured words or the like and the positions of a plurality of designed words or the like. PTL 2 has proposed, as such a device, a technique that sets a particular concavo-convex edge in design data and the edge in measured data that corresponds to the particular concavo-convex edge as the reference points of the design data and the measured data. It has been also proposed to match these reference points, display the design data and the measured data on the same coordinate space, and compare the design data with the measured data.

### CITATION LIST

### Patent Literature

[PTL 1] JP-A-2005-331274

[PTL 2] JP-A-2007-333457

### SUMMARY OF THE INVENTION

### Problem that the Invention is to Solve

When, for example, a plurality of identical characters is provided on the side plate, however, a plurality of concavo-convex edges having the same shape is present on the side plate. Accordingly, in this case, the method that uses concavo-convex edges as reference points cannot easily associate the positions of a plurality of measured words with the positions of a plurality of designed words correctly. In addition, when the design data does not include information about the sizes of characters, since the scale of the measured character cannot match the scale of the designed character, both characters cannot be compared with each other.

The invention addresses the above situations with an object of providing a new method for automatically inspecting whether the side plate has been completed according to the design.

### Means for Solving the Problems

According to an embodiment, an inspection method for inspecting whether a symbol on a side plate of a tire mold matches a designed symbol by comparing a measured image of the side plate with design data, the inspection method including a step of acquiring measured data of the side plate; a step of forming the measured image by imaging the measured data; a step of acquiring the design data of the side plate; a step of constructing a template acquired by imaging a symbol based on the design data; a step of detecting a symbol group including a plurality of the templates; a step of template matching that searches for a symbol set part having the same shape as the symbol group from the measured image, makes a position and a size of the symbol group identical to a position and a size of the symbol set part having been searched for, and superimposes all symbols in the design data whose position and size are associated with the position and the size of the symbol group on all symbols in the measured image; and a step of contour matching that compares contours of the superimposed symbols in the design data with contours of the symbols in the measured image; and a step of deciding whether the symbols corresponding to each other in the measured image and the design data match based on the template matching and the contour matching.

### Advantage of the Invention

The embodiment having such features can provide a new method for automatically inspecting whether a side plate is completed as designed.

### BRIEF DESCRIPTION OF THE DRAWINGS

FIG. 1 is a drawing illustrating an inspection device 10 according to an embodiment.

FIG. 2 is a flowchart illustrating an inspection method according to the embodiment.

FIG. 3 is a drawing that visualizes measured data.

FIG. 4A and FIG. 4B are drawings illustrating a method for converting measured data to an image. FIG. 4A is a perspective view illustrating a convex portion of a measurement target. FIG. 4B illustrates an image of the convex part in FIG. 4A seen from above.

FIG. 5A and FIG. 5B are examples of measured images before and after the uniformization of a character color. FIG. 5A illustrates an example of the measured image before the uniformization of the character color. FIG. 5B illustrates an example of the measured image after the uniformization of the character color.

FIG. 6A and FIG. 6B are drawings illustrating a side plate. FIG. 6A is a plan view illustrating the side plate. FIG. 6B is a cross sectional view taken along line A-A in FIG. 5A.

FIG. 7A to FIG. 7C are drawings used to describe processing for uniformizing the character color. FIG. 7A illustrates a concavo-convex shape in the position corresponding to FIG. 6B. FIG. 7B illustrates the shape of a background in FIG. 7A. FIG. 7C illustrates the shape acquired by subtracting background data from the measured data.

FIG. 8A to FIG. 8C are drawings used to describe the method for constructing a template. FIG. 8A illustrates alphabetic character O assembled by polylines. FIG. 8B illustrates a level 0 region of character O solidly filled with color 0. FIG. 8C illustrates a level 1 region of character O solidly filled with color 1.

FIG. 9A and FIG. 9B are image drawings illustrating design data. FIG. 9A is a drawing illustrating polylines 45, blocks 46, and a reference point 47. FIG. 9B is an enlarged view illustrating the part surrounded by the dotted line in FIG. 9A.

FIG. 10A and FIG. 10B are image diagrams illustrating Polar conversion. FIG. 10A illustrates a design drawing before Polar conversion. FIG. 10B illustrates a design drawing after Polar conversion.

FIG. 11 illustrates an example of a character group.

FIG. 12A and FIG. 12B illustrate a method for template matching. FIG. 12A illustrates how the symbol set part having the same shape as a character group is searched for in a measured image. FIG. 12B illustrates how the size of the character group is changed.

FIG. 13 illustrates how contour matching is performed.

### MODES FOR CARRYING OUT THE INVENTION

An embodiment will be described with reference to the drawings. It should be noted here that the embodiment can inspect various concavo-convex symbols (symbols include characters, marks, and the like) on a side plate, but characters are used in the following description as representative of symbols.

### 1. Structure of an Inspection Device

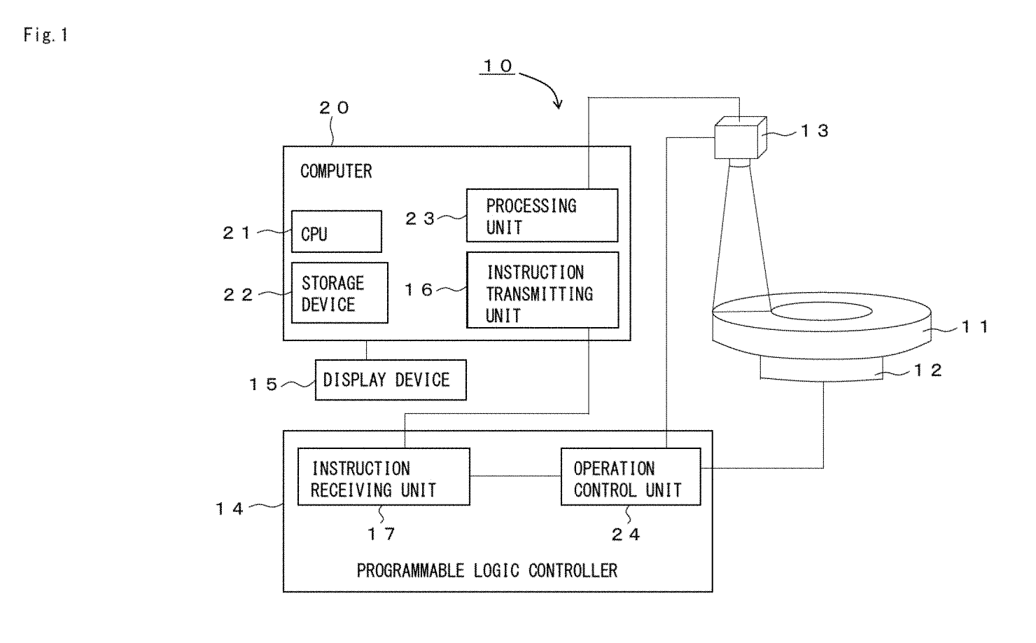

FIG. 1 illustrates an inspection device 10 used for inspection of a side plate (referred to below as the side plate) of a tire mold according to the embodiment. The inspection device 10 includes a rotating platform 11 on which the side plate to be inspected is placed, a driving device 12 that rotates the rotating platform 11, a two-dimensional laser displacement gauge 13 that acquires the profile data (concavo-convex data) of the side plate, a computer 20, and a programmable logic controller (so-called PLC) 14. The inspection device 10 further includes a display device 15 that displays the result of processing by the computer 20 and the like. A device (not illustrated) that adjusts the position of the two-dimensional laser displacement gauge 13 is also provided.

The two-dimensional laser displacement gauge 13 acquires the profile data on a line in the radial direction of the side plate as measured data. When the rotating platform 11 rotates, the profile data at regular intervals in the circumferential direction of the side plate placed on the rotating platform 11 is acquired by the two-dimensional laser displacement gauge 13. While the rotating platform 11 rotates, the position of the two-dimensional laser displacement gauge 13 is fixed. Here, the profile data acquired by the two-dimensional laser displacement gauge 13 includes the data of a character formed as a concave part or a convex part on the side plate.

The two-dimensional laser displacement gauge 13 and the driving device 12 operate based on a control signal from an operation control unit 24 of the programmable logic controller 14. The computer 20 is electrically connected to the programmable logic controller 14 via an instruction transmitting unit 16 and an instruction receiving unit 17 and an instruction for rotating the rotating platform 11 or the like is transmitted from the computer 20 to the programmable logic controller 14. In addition, the measured data acquired by the two-dimensional laser displacement gauge 13 is transmitted to a processing unit 23 of the computer 20.

The computer 20 includes a CPU 21 and a storage device 22. When the CPU 21 executes a program stored in the storage device 22, the processing unit 23 operates and performs the following inspection.

### 2. Inspection Method

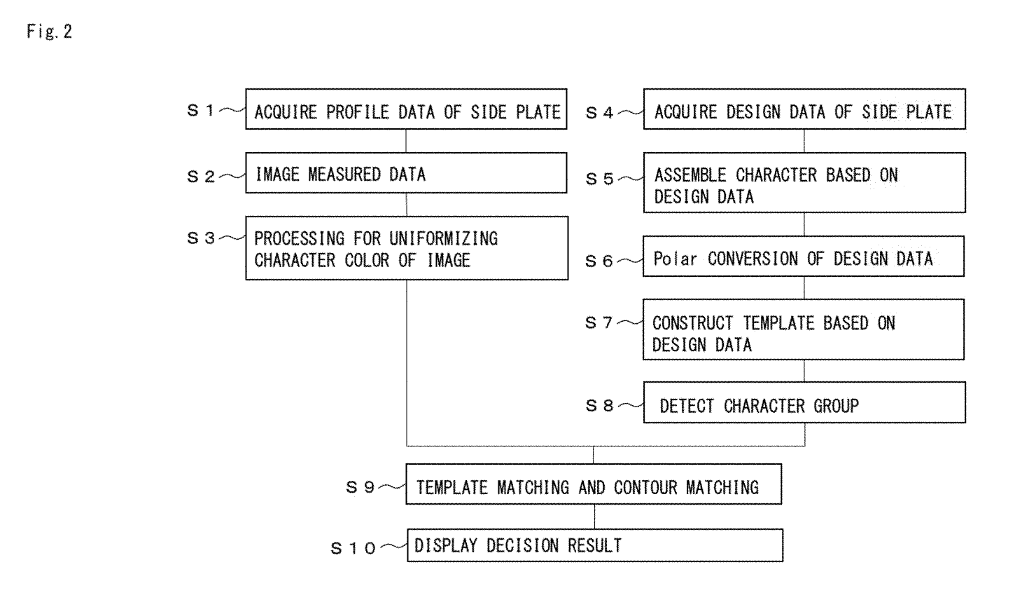

An inspection in the embodiment is performed by the processing unit 23 according to the flowchart illustrated in FIG. 2. Individual steps will be described below in the order indicated by the flowchart in FIG. 2.

(1) From the Acquisition of Measured Data to the Construction of a Measured Image after Uniformization of a Character Color

### (1-1) Acquisition of Measured Data

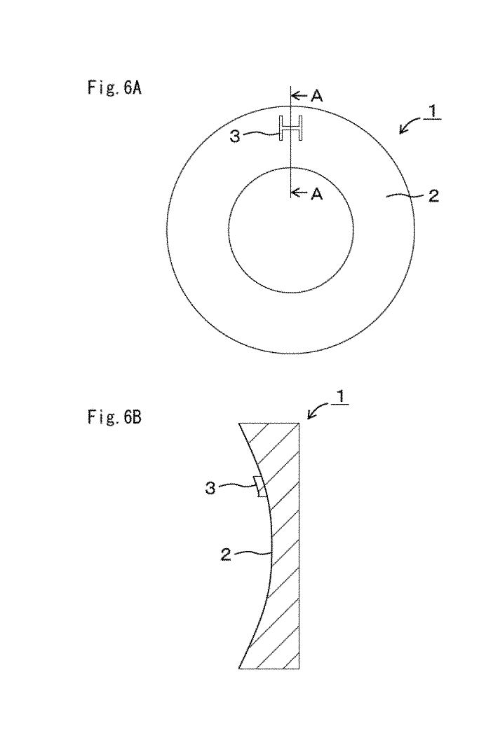

First, the profile data of the side plate (see FIG. 6A and FIG. 6B) is acquired as measured data from the two-dimensional laser displacement gauge 13 (S1 in FIG. 2). Measurement is performed by rotating the side plate by an angle more than 360° (for example, 400°) and the data corresponding to the rotation angle is acquired. After that, the data corresponding to the angle exceeding 360° is cut.

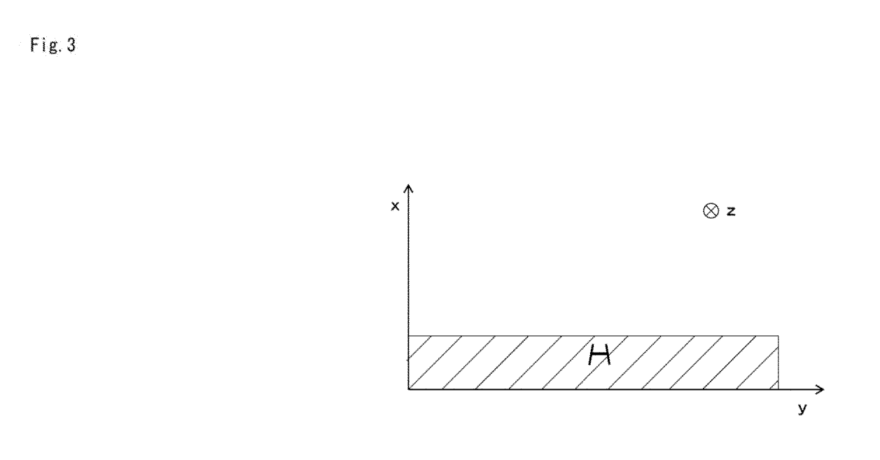

The data acquired when the two-dimensional laser displacement gauge 13 performs measurement once is linear data in the radial direction of the side plate and the linear data for 360° (that is, one orbit of the side plate) is acquired. Accordingly, the side plate is annular, but the measured data acquired by the two-dimensional laser displacement gauge 13 is the data that represents the height in the z-axis direction in the rectangular range (hatched area in FIG. 3) in the xy coordinate system when the size of the rotational angle of the side plate from the measurement start position is y-axis and the measurement range in the radial direction of the side plate by the two-dimensional laser displacement gauge 13 is y-axis, as illustrated in FIG. 3.

### (1-2) Imaging of Measured Data

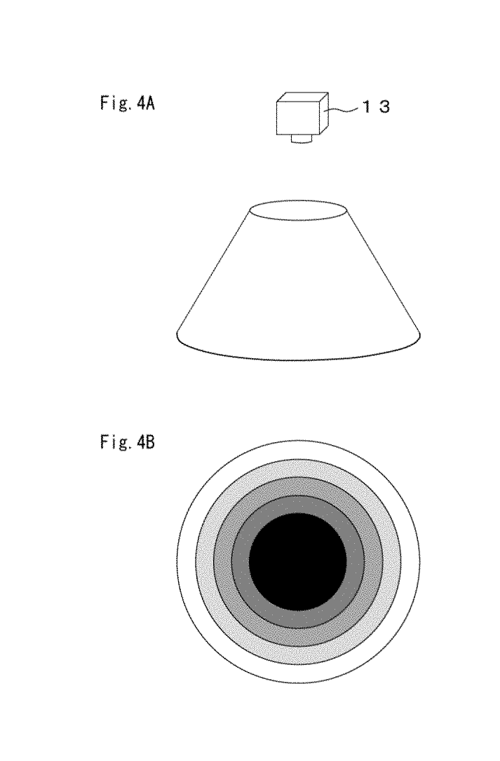

Next, the measured data is imaged (S2 in FIG. 2). In this step, the concavity and convexity based on the measured data are converted into an image having a plurality of tone levels (for example, 256 tone levels). For example, the convex part in FIG. 4A is converted into the image in FIG. 4B so that the part closer to the two-dimensional laser displacement gauge 13 has a darker color and the part more distant from the two-dimensional laser displacement gauge 13 has a brighter color.

In addition, since the character when the side plate is seen from the two-dimensional laser displacement gauge 13 is a so-called mirror character in which the left side and the right side of the original character are exchanged, the character acquired by converting the concavity and convexity based on the measured data into an image is a mirror character. Accordingly, to enable comparison with the character (original character that is not a mirror character) in design data later, conversion into the original character is performed by exchanging the left side and the right side of the character acquired by converting the mirror character into the image. The image acquired by the above conversion is a rectangular image as illustrated in FIG. 3.

In the character in the image acquired by the above conversion, the part of the character radially outside of the side plate is compressed. That is, in the character n the image acquired by the above conversion, as compared with the actual concavo-convex character on the side plate, the part of the character radially outside of the side plate is smaller than the part radially inside of the side plate.

### (1-3) Uniformization of the Character Color

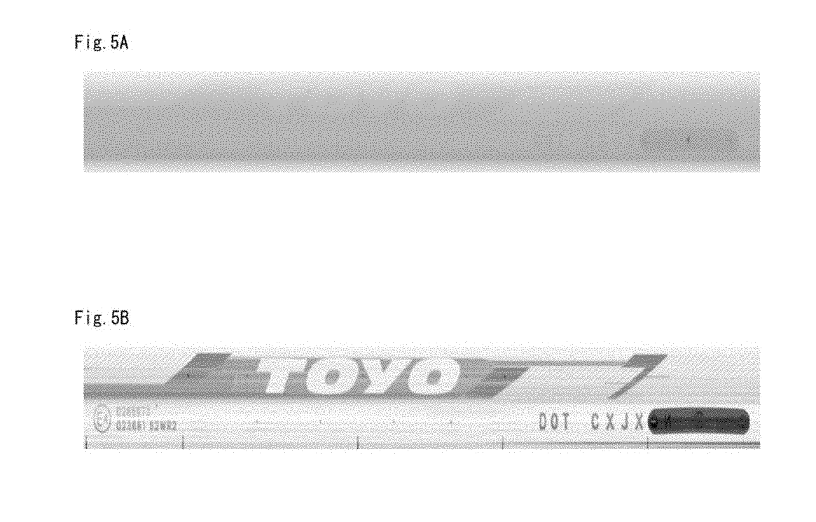

By the way, a molding surface 2 of the general side plate 1 is a curved surface as illustrated in FIG. 6B instead of a flat surface. In addition, a concavo-convex character 3 is provided on the curved molding surface 2. Accordingly, as illustrated in FIG. 5A, in the image acquired by the above conversion based on the measured data, the contrast due to the curve of the molding surface 2 is more outstanding than the contrast due to the concavo-convex character 3.

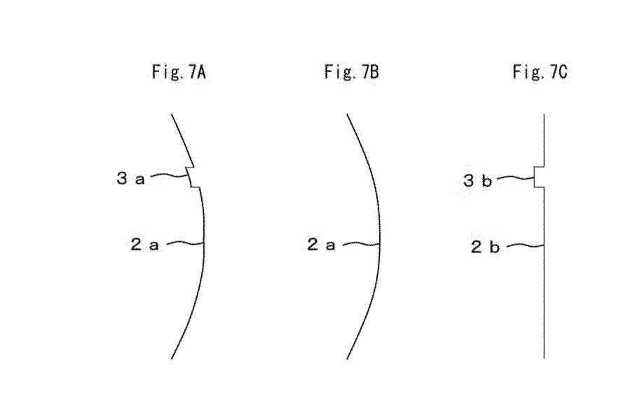

Accordingly, the processing for uniformizing the character color and improving the character contrast is performed on the image acquired by the above conversion based on the measured data (33 in FIG. 2). The concavo-convex shape of the original measured data includes a curved surface part 2a that reproduces the shape of the molding surface 2 from which the concavo-convex character 3 has been removed and a character part 3a that reproduces the shape of the concavo-convex character 3. That is, the concavo-convex shape based on the measured data includes the curved surface part 2a as the background and the character part 3a formed on the background. Accordingly, the processing for subtracting the height value of the curved surface part 2a as the background illustrated in FIG. 7B from the height value of the measured data is performed.

In the concavo-convex shape represented by the data having undergone this processing, as illustrated in FIG. 7C, a part 2b (the curved surface part 2a before the processing) corresponding to the perimeter of the concavo-convex character 3 is a flat surface. In addition, a part 3b (character part 3a before the processing) corresponding to the inside of the concavo-convex character 3 is also a flat surface. Accordingly, when the data having undergone this processing is imaged, the color of the perimeter of the character and the color of the inside of the character are uniformized and the contrast of the character is improved, as illustrated in FIG. 5B.

In addition to this processing, noise is removed, error data is corrected, and the measured data in the unnecessary position is cut as necessary. This improves the contrast of the character.

A “measured image” in the following description represents an image having undergone the above processing unless otherwise specified.

### (2) From the Acquisition Design Data to the Construction of a Template

### (2-1) Acquisition of Design Data

On the other hand, the computer 20 acquires the design data of the side plate (54 in FIG. 2). Although the type of design data is not limited, design data in the embodiment is assumed to DXF data acquired by converting CAD data.

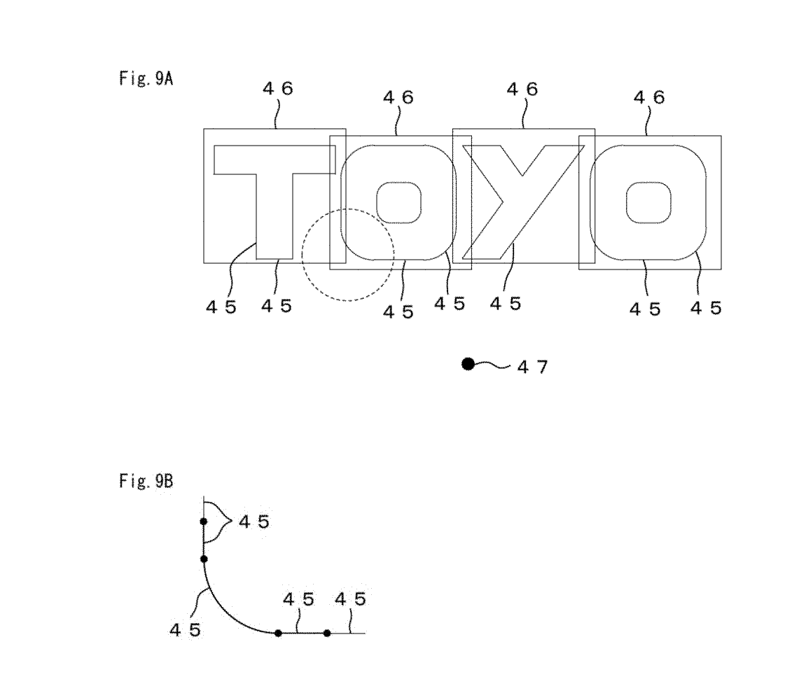

As illustrated in FIG. 9A, design data includes information about polylines 45, blocks 46, and a reference point (also referred to as an insert) 47. The polyline 45 is straight line segments and arc segments created as one object or an object created by combining these segments. As illustrated in FIG. 9B, the plurality of polylines 45 is combined to form the shape of a character. In addition, the block 46 functions as a tab in design data and the one block 46 is assigned to one character (accurately, a set of the polylines 45 that form one character). In addition, for example, the center point of the annular side plate is set as the reference point 47. Each of the blocks 46 represents the position of each character (accurately, a set of the polylines 45 that form one character) with respect to this reference point 47. It should be noted here that design data does not include information about the size of a character (accurately, a set of the polylines 45 that form one character).

### (2-2) Assembling of a Character

Since design data includes information about the polylines 45 that form a character as described above instead of information about a character itself, a character or a word including a plurality of characters cannot be recognized based on design data. Accordingly, an operation that assembles a character based on the polylines 45 is performed (S5 in FIG. 2).

### (2-3) Polar Conversion

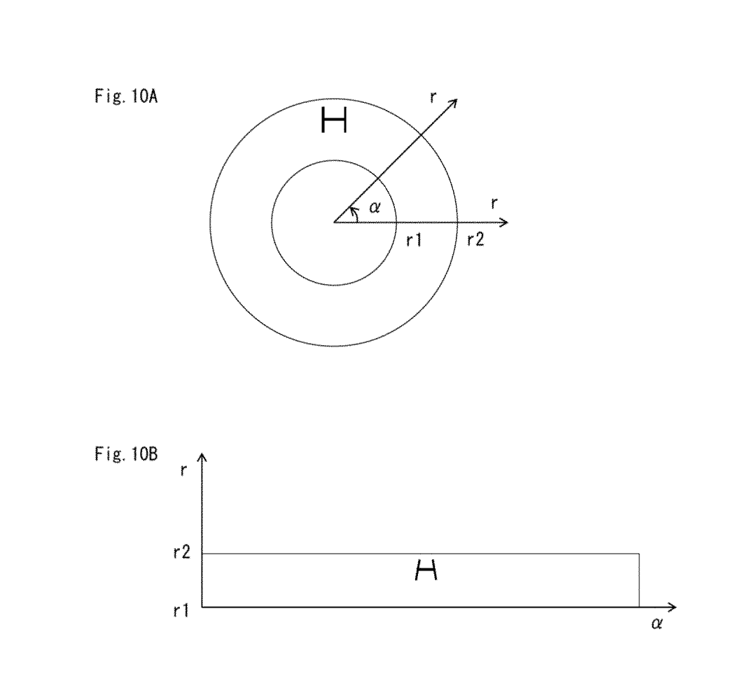

By the way, design data is the data of a design drawing of an annular side plate as illustrated in FIG. 10A. On the other hand, a measured image is a rectangular image as described above. In addition, in a character on a measured image, the part of the character radially outside of the side plate is compressed as compared with the actual character on the side plate. Accordingly, even if the acquired design data is imaged, the imaged design data cannot be used as is for comparison with the measured image.

Accordingly, as the processing for converting the design data representing the annular side plate to the design data representing a rectangle. Polar conversion (Polar transformation) is performed on the design data (S6 in FIG. 2). Polar conversion performs the processing for converting the design drawing of an annular side plate as illustrated in FIG. 10A into a rectangular design drawing as illustrated in FIG. 10B. That is, as a specific example, as illustrated in FIG. 10A, positions on the design drawing of the annular side plate can be represented by radial coordinate r and angular coordinate α in a two-dimensional polar coordinate system. As illustrated in FIG. 10B, r and α described above are two coordinates in the Cartesian coordinate system. As a result of this Polar conversion, the part of the character radially outside of the side plate is compressed in a character on design data. “Design data” in the following description represents design data having undergone Polar conversion unless otherwise specified.

### (2-4) Constructing of a Template

Next, a template to be used in the step of template matching, which will be described later, is constructed based on design data (S7 in FIG. 2). Specifically, each character assembled based on design data is filled and the character filled is imaged to form a template. At this time, the same (that is, corresponding) character color in the measured image is estimated and a character is filled with this color.

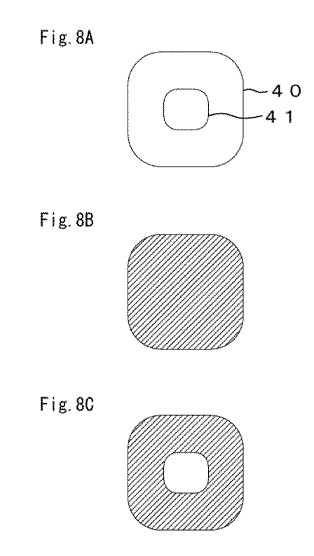

Here, an example of the method for filling a character and an example of the method for constructing a template will be described with reference to FIG. 8A to FIG. 8C. First, a character on design data is classified into levels based on the inclusive relation between shapes formed by the polylines 45. For example, alphabetic character O illustrated in FIG. 8A can be considered to include a large loop 40 formed by the polylines 45 and a small loop 41, formed by the polylines 45, that 15 included in the large loop 40. Acoordingly, the region in the large loop 40 is assumed to be a level 0 region and the region in the small loop 41 is assumed to be a level 1 region. Although not illustrated, when the level 1 region further includes shapes formed by the polylines 45, the regions in the shapes are assumed to be level 2 and subsequent regions.

Next, two colors (assumed to be color 0 and color 1) are prepared and the level 0 and subsequent regions are filled with these two colors alternately. In the case of character O, as illustrated in FIG. 8B, the level region is filled with color 0 and, as illustrated in FIG. 8C, the level 1 region is filled with color 1. Although not illustrated, when level 2 and subsequent regions are present, these regions are filled with color 0 and color 1 sequentially (that is, the level 2 region (if any) is filled with color 0 and the level 3 region (if any) is filled with color 1).

Here, the character color (which may be an estimated color) in the measured image is selected as color 0. In addition, the background color (which may be an estimated color) in the measured image is selected as color 1.

When the character is filled in this way, a template of a character filled with color 0 is completed.

By the way, the color of a character in a measured image significantly changes depending on whether the character projects or is depressed on the side plate. Accordingly, the color (referred to below as the projecting color) when the character projects on the side plate and the color (referred to below as the depressed color) when the character is depressed on the side plate are selected as color 0 that is the color of the character. As a result, two templates (for the projecting color and the depressed color) are created for one character.

The construction of templates as described above is performed for all characters assembled based on design data.

### (2-5) Detection of a Character Group

Before the next template matching, one character group (that is, a set of templates) is detected from parts (a plurality of characters) of all characters for which templates have been created (S8 in FIG. 2). It should be noted here that a “character group” is narrower concept of a “symbol group” that includes a plurality of sets of symbols.

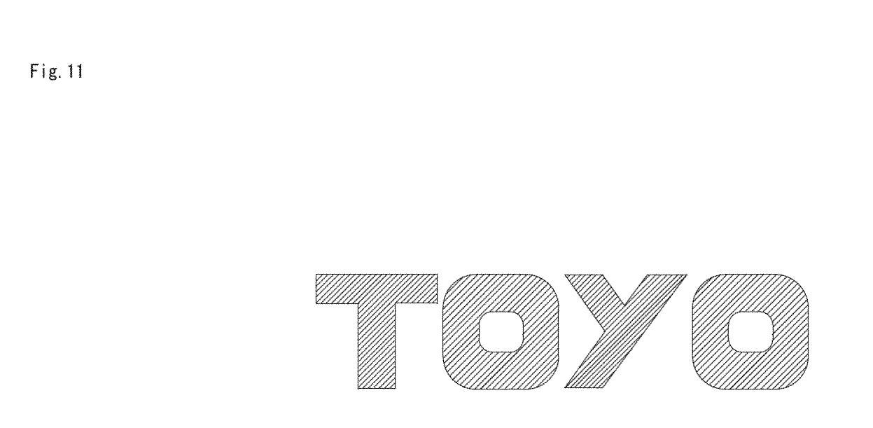

A character size or a character spacing is used to detect a character group. For example, assuming that characters that have the same size and a small spacing form one character group, a character group is detected. When a character group is detected using a character spacing, a known clustering method can be used. A character group detected in this way forms, for example, one word. A character group is preferably configured by uppercase characters. FIG. 11 illustrates an example of a character group. In FIG. 11, the hatched area is the color 0 region. Two character groups for a projecting color and a depressed color are prepared.

### (3) From Matching to the Displaying of the Result

### (3-1) Template Matching

After a measured image constructed based on measured data and a template and a character group constructed based on design data are prepared as described above, template matching is performed (S9 in FIG. 2).

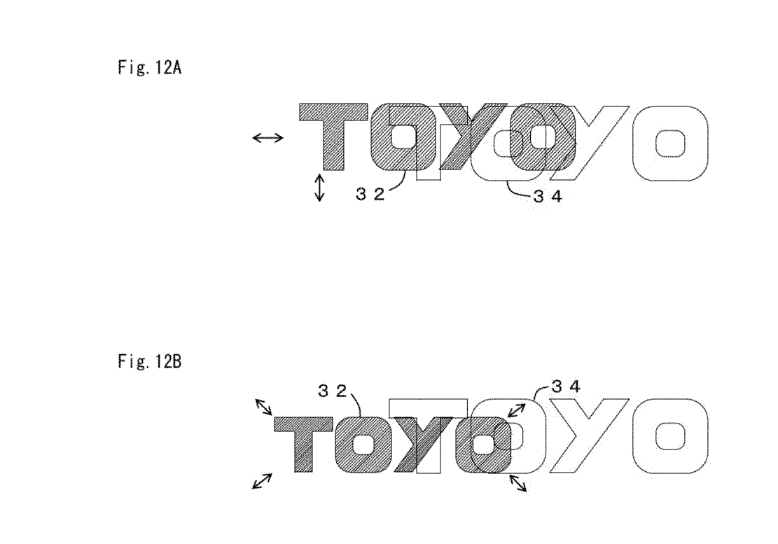

First, a character set part 34 (that is, a part including a plurality of characters) having the same shape as a character group 32 is searched for in a measured image as indicated by arrows in FIG. 12A. When the character set part 34 having the same shape as the character group 32 is found in the measured image, the position of the character group 32 is determined.

Since design data does not include information about the size of a character, the size of the template or the character group constructed based on design data are not determined. Then, the size of the character group 32 is changed as indicated by arrows in FIG. 12B to make the size of the character group 32 identical to the size of the character set part 34 having the same shape as the character group 32 in the measured image.

Since two types for a projecting color and a depressed color are present as the character group 32 as described above, the operation for making the position and the size of the character group 32 identical to those of the corresponding character set part 34 in the measured image is performed using these two types of character groups 32. This makes the character group 32 favorably identical to the character set part 34 when the character group 32 of one of these two colors is used.

The position and the size of the character group 32 are determined as described above. The relationship between the positions and the sizes of the character group 32 and a template other than the character group 32 can be seen from design data. Accordingly, if the position and the size of the character group 32 are determined, the positions and the sizes of all templates other than the character group 32 are determined.

After the positions and the sizes of all templates are determined, the positions and the sizes of the templates are fine-tuned individually so that the templates are accurately superimposed on the characters in the measured image that correspond to the templates. This fine-tuning is performed for each template. In addition, the template for a projecting color and the template for a depressed color are used for this fine-tuning and the fine-tuning can be performed well when one of these templates is used.

By the template matching performed as described above, all characters in the design data can be super imposed on ail characters in the measured image across the entire side plate.

### (3-2) Contour Matching

Contour matching is performed in the state in which all characters in the design data are superimposed on all characters in the measured image (S9 in FIG. 2). In the contour matching, the contours (that is, the polylines 45) of the characters in the design data are compared with the contours of the characters in the measured image.

For the purpose of the contour matching, the contours of the characters in the measured image are first extracted. In the extracting of the contours, by using, as the threshold, the tone level of a color between the color of the characters and the color of the background in the measured image, the data of the measured image is binarized so that the characters are white and the background is black or the characters are black and the background is white. This binarization eliminates the part in which the color changes slightly in the background of the measured image and extracts only the contours of the characters.

Next, the contours of the characters in the design data are compared with the contours of the characters extracted from the measured image. This comparison is performed for each character. That is, when the contour of the design data is compared with the contour in the measured image for a certain character, the contours of the other characters are ignored. This comparison is performed for each of all characters.

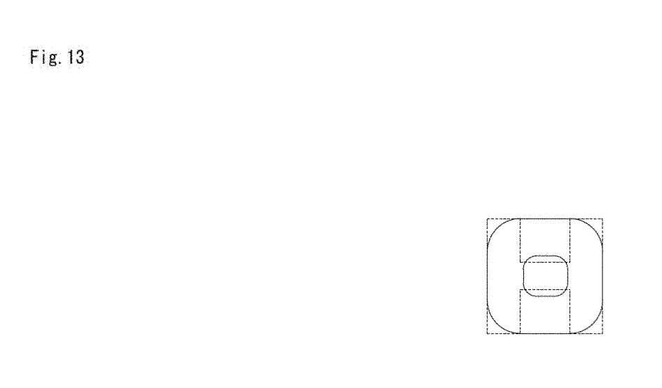

FIG. 13 illustrates an example of contour matching when the character in the measured image does not match the character in the design data. In FIG. 13, the solid lines represent the character in the measured image and the dashed lines represent the character in the design data.

### (3-3) Decision and Indication of Results

As a result of the template matching and the contour matching described above, whether the characters in the measured image match the characters in the design data is decided for each character. That is, whether the characters in the measured image match the characters in the design data is decided for each character by determining whether all templates are superimposed on all characters in the measured image in template matching and whether the contours of characters in the design data match the contours of characters in the measured image in contour matching.

Finally, the decision result is displayed on the display device 15 (S10 in FIG. 2). In the method for displaying the decision result, for example, the measured image is displayed on the display device 15 and the characters that do not match the design data and the characters that match the design data are indicated in different colors in this display. The inspector can know that the side plate has been completed according to the design based on the display.

### 3. Effect of the Embodiment

As described above, in the embodiment, the templates corresponding to individual characters in the design data are constructed and one character group is detected from the plurality of templates. Then, the character set part having the same shape as the character group is searched for in the measured image and the positions and the sizes of the character group and the character set part having been searched for are made identical. This can superimpose another template for which the position and size are associated with the character group on the character in the measured image. In this way, all characters in the design data can be easily superimposed on all characters in the measured image.

Here, a character group is constructed by a plurality of templates. Accordingly, even when a plurality of the same characters is provided or similar characters are provided on the side plate, these characters do not cause a problem when the character set part having the same shape as the character group is searched for in the measured image.

In addition, since the size of a character group is made identical to the size of the character set part corresponding to the character group, even when design data does not include information about the sizes of characters, all characters in the design data can be superimposed on all characters in the measured image.

As described above, the embodiment provides a new method for automatically inspecting whether the side plate has been completed according to the design.

In addition, the embodiment first extracts the contours of characters in the measured image in contour matching and compares the extracted contours with the contours of the characters in the design data. Accordingly, it is possible to prevent an erroneous decision from being made because the part in which the color changes slightly in the measured image is detected as the contour.

In addition, this contour matching is performed for each character. That is, when the contour in the design data is compared with the contour in the measured image for a certain character, the contours of the other characters are ignored. Accordingly, when comparison is performed on a certain character, the effect of an adjacent character can be eliminated.

In addition, in the embodiment, a two-dimensional laser displacement gauge is used to acquire measured data. Accordingly, unlike a two-dimensional camera that takes a flat image or a line camera (line sensor) that forms a flat image by combining a plurality of one-dimensional images, a two-dimensional laser displacement gauge does not need illumination or focus adjustment. In addition, although a three-dimensional laser displacement gauge has problems in that the gauge is expensive and not widely used, the data processing becomes slow or complicated because a large amount of data needs to be acquired, and the like, a two-dimensional laser displacement gauge does not have such problems.

In addition, since measured data is acquired by a two-dimensional laser displacement gauge in the embodiment, the measured data is acquired as data about a curved surface and concavo-convex characters formed on the curved surface and changes in color by the curved surface are caused in the measured image if the measured data is imaged as is. However, in the embodiment, since the embodiment converts the data representing a curved surface in the measured data into the data representing a flat surface and images the converted data like the character color uniformization processing described above, changes in the color by the curved surface can be eliminated. As a result, the color inside the character can be uniformized.

In addition, the embodiment converts the design drawing of an annular side plate into a rectangular design drawing in imaging design data, a design data image can be compared with a rectangular measured image by superimposing the design data image on the rectangular measured image.

The embodiment described above is only an example and the scope of the invention is not limited by the embodiment. Various modifications can be made to the embodiment described above without departing from the spirit of the invention. For example, the order of steps may be changed as long as the final decision is enabled.

### DESCRIPTION OF REFERENCE SIGNS AND NUMERALS

1: side plate, 2: molding surface, 2a: curved surface part, 2b: part corresponding to perimeter of concavo-convex character 3, 3: concavo-convex character 3a: character part, 3b: part corresponding to inside of concavo-convex character 3, 10: inspection device, 11: rotating platform, 12: driving device, 13: two-dimensional laser displacement gauge, 14: programmable logic controller, 15: display device, 16: instruction transmitting unit, 17: instruction receiving unit, 20: computer, 21: CPU, 22: storage device, 23: processing unit, 24: operation control unit, 32: character group, 34: character set part, 40: large loop, 41: small loop, 45: polyline, 46: block, 47: reference point

1. An inspection method for inspecting whether a symbol on a side plate of a tire mold matches a designed symbol by comparing a measured image of the side plate with design data, the inspection method comprising:
a step of acquiring measured data of the side plate;
a step of forming the measured image by imaging the measured data;
a step of acquiring the design data of the side plate;
a step of constructing a template acquired by imaging a symbol based on the design data;
a step of detecting a symbol group including a plurality of the templates;
a step of template matching that searches for a symbol set part having the same shape as the symbol group from the measured image, makes a position and a size of the symbol group identical to a position and a size of the symbol set part having been searched for, and superimposes all symbols in the design data whose position and size are associated with the position and the size of the symbol group on all symbols in the measured image; and
a step of contour matching that compares contours of the superimposed symbols in the design data with contours of the symbols in the measured image; and
a step of deciding whether the symbols corresponding to each other in the measured image and the design data match based on the template matching and the contour matching.

2. The inspection method for the side plate of the tire mold according to claim 1,
wherein the step of the contour matching includes a step of extracting a contour of the symbol in the measured image and a step of comparing the extracted contour with a contour of the symbol in the design data for each symbol.

3. The inspection method for the side plate of the tire mold according to claim 1,
wherein the measured data is acquired by a two-dimensional laser displacement gauge.

4. The inspection method for the side plate of the tire mold according to claim 1,
wherein the measured data is acquired as data about a curved surface and a concavo-convex symbol formed on the curved surface, and
the step of forming the measured image by imaging the measured data includes a step of converting data indicating the curved surface in the measured data into data indicating a flat surface and a step of imaging the converted data.

5. The inspection method for the side plate of the tire mold according to claim 1, further comprising:
a step of converting a design drawing of an annular side plate into a rectangular design drawing,
wherein the measured image is a rectangular image.
